(19) United States
(12) Patent Application Publication
(10) Pub. No.: US 2010/0132404 A1
(43) Pub. Date: Jun. 3, 2010

(54) BONDS AND METHOD FOR FORMING BONDS FOR A TWO-PHASE COOLING APPARATUS

(75) Inventor: Ahmed Shuja, Richmond, CA (US)

Correspondence Address: PERKINS COIE LLP, P.O. BOX 1208, SEATTLE, WA, 98111-1208, US

(73) Assignee: Progressive Cooling Solutions, Inc., Berkeley, CA (US)

(21) Appl. No.: 12/327,728

(22) Filed: Dec. 3, 2008

(51) Int. Cl. F25B 39/02; B23P 11/00

(52) U.S. Cl. 62/524; 29/428

(57) ABSTRACT

Bonds and method for forming bonds for a two-phase cooling apparatus are disclosed. In one aspect of the present disclosure, the two-phase cooling apparatus includes an evaporator. One embodiment of the evaporator includes, a first layer having porous regions and non-porous regions, the porous regions having a plurality of through-holes extending through the first layer, a cap structure formed such that when disposed over the first layer, at least a portion of the plurality of through-holes are unobstructed to liquid or vapor flow, a bonding layer formed between the first layer and the cap structure, the bonding layer in contact with at least a portion of the non-porous regions of the first layer, the bonding layer comprising a bond. The bonding layer is typically compatible with liquid and forms a hermetic seal between the first layer and the cap structure

### TECHNICAL FIELD

The techniques are generally related to the field of wafer bonding, in particular, forming bonds that are compatible with liquids for a two-phase cooling application.

### BACKGROUND

In the operation of a two-phase cooling apparatus, cooling is typically achieved through vaporization of liquid through the device. Due to the operating principals of the two-phase cooling apparatus, unique sets of criteria are commanded for wafer bonding the evaporator to ensure reliability and robustness during operation with high temperature devices and frequent heat cycling.

### BRIEF DESCRIPTION OF THE DRAWINGS

FIG. 1 illustrates a system view of a two-phase cooling apparatus configured for cooling a processor, according to one embodiment.

FIG. 2A illustrates a cross sectional view of an evaporator of a two-phase cooling apparatus having the cap structure partially cut-away, according to one embodiment.

FIG. 2B illustrates a cross sectional view of the evaporator with the cap structure removed showing the bond and an enlarged view of the compositions of the bonding layer relative to the porous regions and non-porous regions, according to one embodiment.

FIG. 3 illustrates a cross sectional view of the evaporator showing surface topology between the pore arrays, according to one embodiment.

FIG. 4 illustrates a side view of the evaporator showing an example of the compositions of the bonding layer on the cap structure and the layer with porous regions and non-porous regions, according to one embodiment.

FIG. 5 illustrates a side view of the evaporator showing a further example of the compositions of the bonding layer on the cap structure and the layer with porous regions and non-porous regions, according to one embodiment.

FIG. 6 illustrates a diagrammatic view of the porous semiconductor layer showing the array of the pores (capillaries), according to one embodiment.

FIG. 7 is an SEM image showing a patterned array of pores in the semiconductor layer of the evaporator, according to one embodiment.

FIG. 8 is a flow chart illustrating a process for forming an evaporator of a two-phase cooling apparatus, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include bonds and method for forming bonds for a two-phase cooling apparatus.

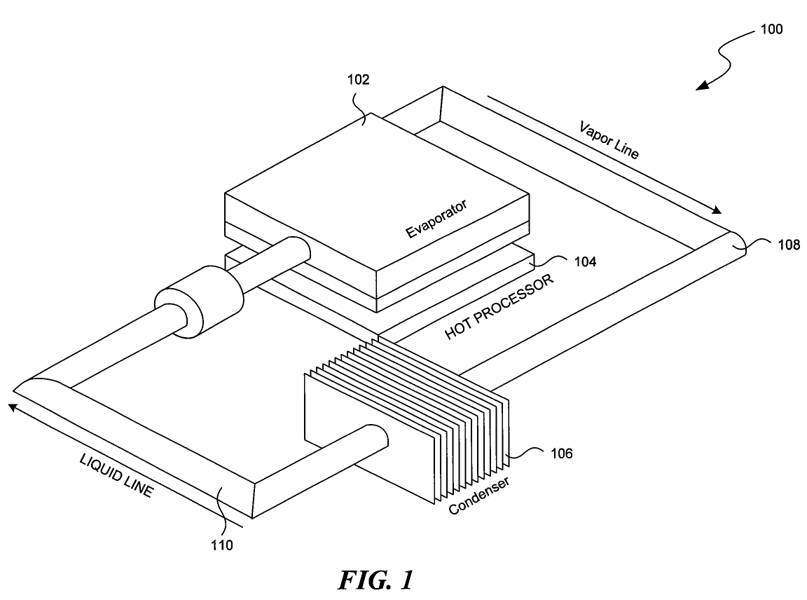

FIG. 1 illustrates a system view 100 of a two-phase cooling apparatus configured for cooling a processor 104, according to one embodiment.

The system of a two-phase cooling apparatus typically includes an evaporator 102 thermally coupled to a processor 104. The evaporator 102 can further be connected to a condensor 106 via a vapor line 108 through which vapor generated can exit the evaporator 102 to the condensor 106 where the vapor condenses to liquid. The liquid can subsequently enter the evaporator 102 through the liquid like 110. In general, vapor is generated when the liquid in the evaporator 102 absorbs the heat generated by the processor 104, or any other device that generates heat.

Additional examples regarding the cooling operation of the two-phase cooling apparatus is described with reference to co-pending U.S. patent application Ser. No. 11/530,107 entitled “SYSTEM AND METHOD OF A POROUS SEMICONDUCTOR-BASED EVAPORATOR”, filed Sep. 8, 2006, which is incorporated by reference herein.

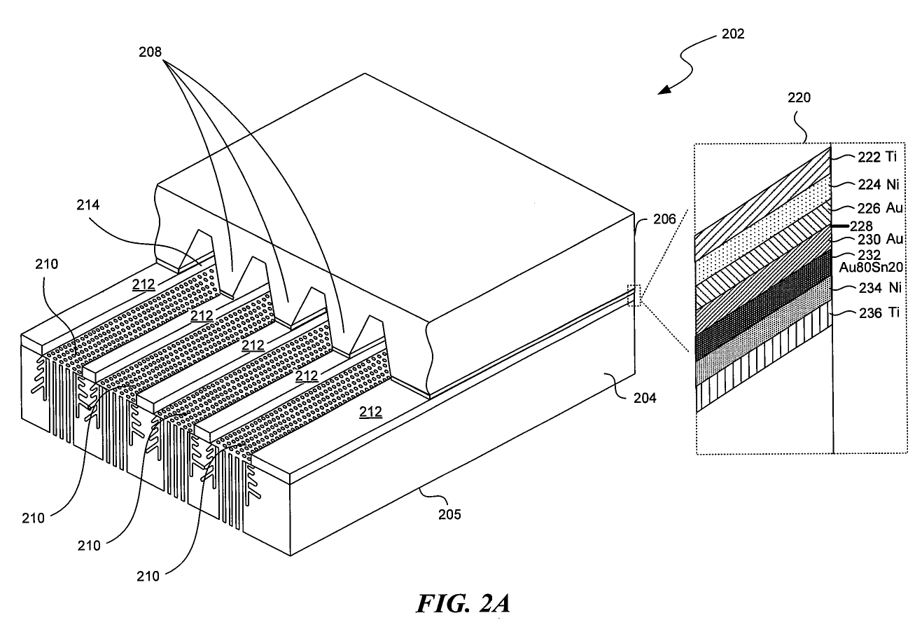

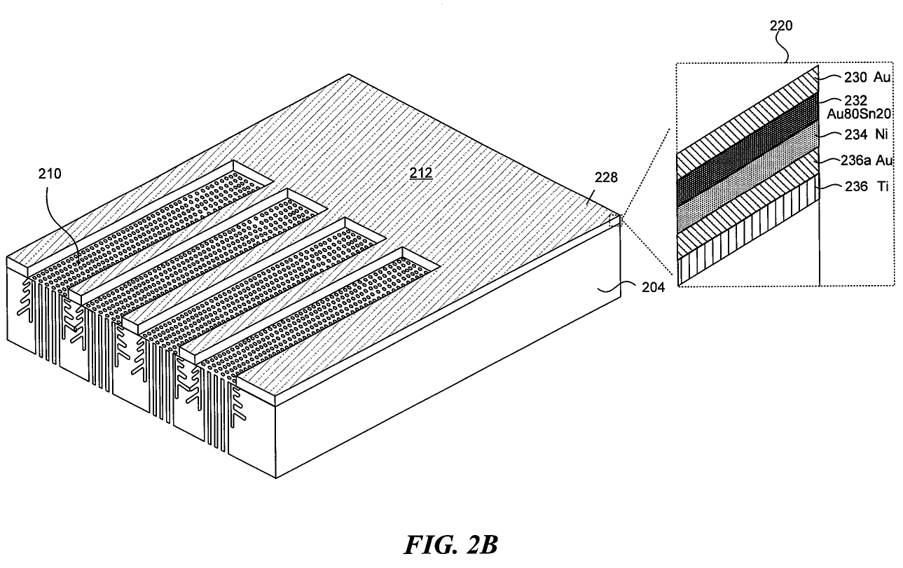

FIG. 2A illustrates a cross sectional view of an evaporator 202 of a two-phase cooling apparatus having the cap structure 206 of the evaporator 202 partially cut-away, according to one embodiment.

The evaporator 200 typically includes a first layer 204 having porous regions 210 and non-porous regions 212. The porous regions 210 include pluralities of through-holes that extend through the first layer 204, thus allowing liquid and/or vapor to pass through the first layer 204 and into the unobstructed regions 214 between the first layer 204 and the cap structure 206. The first layer 204 can be thermally coupled to a cap structure 206 such that the heat emitted from a heated device thermally coupled to the cap structure 206 can be transferred to the first layer 204.

In general, the cap structure 206 is formed such that when disposed over the first layer 204, at least a portion of the plurality of through-holes are unobstructed to liquid or vapor flow. For example, there may be open regions 214 when the cap structure 206 is placed over the first layer 204. In one embodiment, the first layer 204 comprises substantially of crystalline semiconductor such as crystalline silicon.

When heat from the heated device that is thermally coupled to the evaporator 202 is transferred to the first layer 204, liquid in the evaporator 202 rises into the pores and vaporizes. The liquid is typically provided to the evaporator 202 through the lower side 205 of the first layer 204. The lower side 205 of the first layer 204 is opposite to the side connected with the cap structure 206. The vaporization absorbs latent heat and cools the heated device that is thermally coupled to the evaporator 202. The cap structure 206 of the evaporator 202 is typically made from thermally conductive material such that heat from a device coupled to the cap structure 206 can be efficiently thermally coupled to the first layer 204. In one embodiment, the cap structure 206 is formed with protruding structures 208 that extend toward and are in contact with the first layer 204.

In one embodiment, the evaporator 202 includes a bonding layer 220 formed between the first layer 204 and the cap structure 206. The bonding layer 220 is formed such that it is in contact with at least a portion of the non-porous regions 212 of the first layer 204 such that at least some of the through-holes in the porous regions 210 remain unobstructed to liquid and/or vapor flow. The protruding structures 208 are typically in contact with the bonding layer 220.

One embodiment of the bonding layer 220 includes a seed layer 222, a barrier layer 224, and/or a capping layer 226. For example, the cap structure 206 can be coated with the seed layer 222 then deposited with the barrier layer 224. The capping layer 226 may then be formed over the barrier layer 224.

The first layer 204 can be coated with a seed layer 236 then deposited with barrier layer 234. A bond comprising a solder layer 232 can be formed over the barrier layer 234 and then deposited with a capping layer 230. The bonding layer 220 is formed at the bond interface 228 where the capping layer 226 and the capping layer 230 are connected. Although seven layers are illustrated in the bonding layer 220, additional or less layers may included in the bonding layer 220 as suitable for the application or bonding mechanism without deviating from the novel art of the disclosure.

Note that the bonding layer 220 is generally compatible with liquid or compatible with liquid under specified environmental/operating conditions (e.g., temperature, pressure, type of liquid, etc.). In particular, the bonding layer 220 is compatible with liquid of elevated temperatures since, during operation, the evaporator 202 is thermally coupled to a heated device cooled by vaporization of the liquid. Furthermore, the bonding layer 220 is compatible with the cap structure 206 and the first layer 204 having elevated temperatures since the cap structure 206 is, in some instances, connected with the heated device to be cooled. The elevated temperatures can be anywhere between, by way of example, but not limitation, 35-200 C. Furthermore, the bonding layer 220 is typically compatible with liquid through thermal heat cycles (e.g., or repetitions of heating and cooling) resulting from cooling of the heated device.

In addition, the bonding layer 220 forms a seal that is generally hermetic or hermetic under specified environmental/operating conditions between the first layer 204 and the cap structure 206. The hermetic seal allows the two-phase cooling apparatus to operate at sub ambient pressures over extended periods of time and through heat cycling. In particular, the bonding layer 220 is hermetic and remains hermetic when the liquid and surrounding structures (e.g., the cap structure 206 and the first layer 204) are of elevated temperatures and through thermal heat cycles.

The bonding layer 220 may also preferably be thermally conductive (e.g., approximately or greater than 50 W/mK) and have a reasonably long lifetime (e.g., >˜50,000 hours). Note that since the evaporator 202 is exposed to heat during operation and subsequently removes the heat via vaporization, the bonding layer 220 is also ideally resistant to thermal cycling to ensure robustness and structural integrity of the bonding layer 220. Furthermore, the bonding layer 220 can generally be made from a process suitable for mass production, for example, using existing state-of-the-art procedures and equipment.

The bond comprising the solder layer 232 can include an alloy of gold (Au) and tin (Sn). The composition may be approximately 80% gold and 20% tin. Alternatively, the solder layer 232 can include an alloy of gold (Au) and copper (Cu), with a composition of approximately 30% gold and 70% copper. The solder layer 232 can also include an alloy of gold (Au) and indium (In). The alloy of gold and indium is advantageous in that it forms around or slightly above 157 C and the alloy will withstand temperatures up or around 457 C.

In another embodiment, the solder layer 232 can include an alloy of nickel (Ni) and gold (Au) of approximately 18% nickel and 81.5% Au. The bond 222 may include an alloy of copper (Cu) and silver (Ag) of, for example, 28% and 72% respectively. The bond may include an alloy of tin (Sn) and silver (Ag) of approximately 96.5% and 3.5%, respectively.

In one embodiment, the solder layer 232 includes SAC305, tin (Sn), silver (Ag), and copper (Cu), of, for example 96.5% tin, 3% silver, and 0.05% copper. This alloy can be formed at approximately 220 C. In yet a further embodiment, the solder layer 232 comprises substantially of, one of, SAC105, SAC205, and SAC405. The first digit in each number signifies the amount of (Ag ) silver and second digit refers to the amount of (Cu) copper. In general, the SAC alloys can liquefy between approximately 226 C and 240 C. The alloy bond layer 232 in another embodiment can include Tin (Sn) and silver (Ag) with an alloy composition of 96.5 tin and 3.5% silver. The tin/silver alloy is typically able to liquefy around approximately 221 C.

In one embodiment, the solder bond 232 comprises an alloy of gold (Au) and tin (Sn). The composition may be approximately 80% gold and 20% tin. After reflow, the Au80Sn20 alloy can intermix with the gold in the capping layers 226 and 230. After intermixing, the reflow temperature of the resulting alloy typically increases thus making it capable of withstanding temperatures greater then 280 C (the original reflow temperature for the Au80Sn20 eutectic alloy). The Au80Sn20 alloy can be used when the cap structure temperature does not have maximum temperature constraints. The high bond temperature for forming the Au80Sn20 alloy can enhance bond integrity in later steps.

In one embodiment the solder bond 232 can be formed by a eutectic reaction between capping layers 226, 230 comprised of gold and the cap structure 206. In this situation, the barrier layer 224 is not formed on the cap structure 206. The solder bond 232 formed by eutectic reaction can form around or at 363 C but can generally withstand up to approximately 800 C in subsequent processing.

In one embodiment, the bond solder 232 can include an alloy of gold (Au) and Indium (In), with a composition of approximately 82% gold and 18% Indium. The gold (Au) and Indium (In) alloy can be formed with a bonding temperature of approximately 450 C. In one embodiment, the solder alloy 232 includes an alloy of Silver (Ag) and Copper (Cu) of approximately 72% and 28%, respectively. The silver and copper alloy has a reflow temperature of approximately 780 C. In one embodiment, the alloy solder 232 includes an alloy of gold (Au) and copper (Cu), with a composition of approximately 80% gold and 20% copper. The gold and copper alloy typically has a reflow temperature of 890 C.

In one embodiment, the solder alloy 232 includes an alloy of gold (Au) and nickel (Ni) of approximately 82% Au and 18% nickel. The gold and nickel alloy has a reflow temperature of 950 C. In addition, the solder alloy 232 may include an alloy of copper (Cu), Tin (Sn) and silver (Ag) of, for example, 85%, 8% and 7% respectively. The copper, tin, and silver alloy can have a reflow temperature of 985 C.

Note that the solder alloy 232 can be any suitable thickness, for example, between 1000-20,000 nm but more preferably between 2000-5000 nm. For example, thicknesses of 2000 nm, 2500 nm, 3000 nm, 3500 nm, 4000, 4500, or 5000 nm maybe used. In general, a thicker layer of solder alloy 232 (e.g., 15,000-20,000 nm) can be used to compensate for the surface roughness of the first layer 204. In one embodiment, the solder alloy 232 is approximately at least 1.5-3 times the surface roughness of the material on which the solder alloy 232 is formed. For example, if the first layer 204 has surface roughness of 1000 nm. then the bonding layer 220 can be at least 1500-3000 nm.

One embodiment of the bonding layer 220 includes seed layers 222 and/or 226. The seed layers 222 and/or 236 can have any suitable thickness which may vary with type of material used but can be approximately anywhere between 30-250 nm but more preferably around 40-60 nm, for example approximately 50 nm in thickness. The seed layer (adhesion layer) can to promote adhesion of the bonding layer 220 to the underlying material (e.g., silicon/silicon dioxide or silicon nitride, etc.). For example, the seed layer 236 can be deposited on the first layer 204 to promote adhesion of the remaining layers of bonding layer 220 to the first layer 204. The seed layer 222 or 226 (or also referred to as an adhesion layer) can include, one or more of, aluminum (Al), chromium (Cr), titanium (Ti), and titanium-tungsten (TiW).

One embodiment of the bonding layer 220 includes a barrier layer (e.g., the barrier layers 224 and/or 234) The barrier layers 224 and/or 234 can be deposited over the seed layers 222 and 236, respectively, to mitigate diffusion of the alloy bond 232 into the underlying material (e.g., the first layer 204 and/or the cap structure 206). In one embodiment, the barrier layers 224 and/or 234 comprise nickel (Ni). In some embodiments, the barrier layer 224, 234 can include materials including but not limited to, one or more of, gold (Au), platinum (Pt), nickel/chromium alloy, tantalum (Ta), hafnium (Hf), niobium (Nb), zirconium (Zr), vanadium (V), Molybdenum (Mo), and tungsten (W). The barrier layer 226 can also be formed of conductive ceramics, including, one or more of, tantalum nitride (TaN), indium oxide (In₂O₃), copper silicide (Cu₅Si), and titanium nitride (TiN).

The barrier layer 226 can be any suitable thickness, for example, anywhere between the range of 100-2000 nm although more preferably between 200-300 nm, such as approximately 200 nm for bonding temperature <280 C. In general, the barrier layer thickness can be determined based on a function of the diffusion coefficients of the metals in the bond 232 and temperature for forming the bond. For example, when the solder layer 232 includes an alloy of gold (Au) 80% and tin (Sn) 20%, the diffusion coefficient of the solder layer 232 into the barrier layer 226 becomes important because the solder may de-wet the seed layer 236 causing de-lamination of the bonding layer 220 from the first layer 204 of the evaporator 202.

One embodiment includes capping layers 226 and/or 230 deposited over the bond 232 to prevent oxidation of any composite material in the bond 232 (e.g., the tin in the gold/tin alloy). The capping layer typically includes gold (Au) because it does not easily oxidize in air or liquid. The thickness of the capping layers can be anywhere between 30 to 150 nm although more preferably around 40-60 nm, for example 50 nm.

FIG. 2B illustrates a cross sectional view of the first layer 204 without the cap structure, according to one embodiment.

The capping layer 236a can be deposited over the seed layer 236 to prevent oxidation that may occur between thin film sputtering/evaporation and electroplating processes. Electroplating can be used to form thicker layers. The layers 230, 232, and/or 234 can be formed by electroplating when larger thicknesses are needed (e.g., >5000 nm.) since sputtering may yield unfavorable results. For example, if the surface roughness of the first layer 204 is such that the thickness of the bond 232 (e.g., >2000-3000 nm.) cannot be reliably deposited by sputtering, electroplating can be used to form the bond 232. Precautions are typically be made to not allow the layers 234, 232 and/or 230 to flow into the porous regions 210 and clog the through-holes during reflow. It is for this reason that the bonding layer 220 generally is patterned 212.

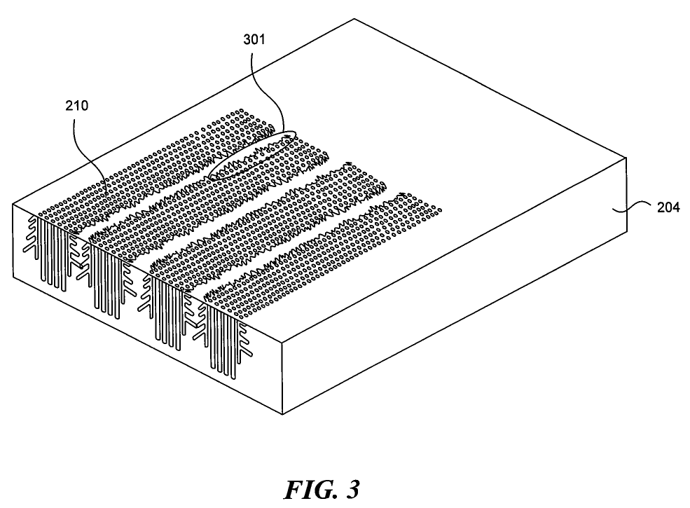

FIG. 3 illustrates a cross sectional view of the first layer 204 showing surface topology 301 between the porous regions 210, according to one embodiment.

The surface topology 301 is generally created during microfabrication of the through-holes in the porous regions 210. Due to the presence of surface topology 301, in one embodiment, usage of alloy bonds can overcome this defect because the solder can flow into the defects in liquid state. The effects of the presence of surface topology 301 can thus in some instance be mitigated to improve the results of bonding.

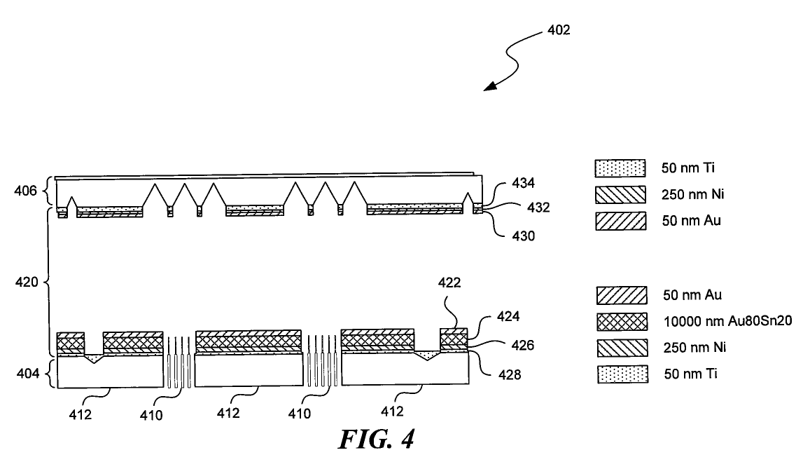

FIG. 4 illustrates a side view of the evaporator 402 showing an example of the compositions of the bonding layer 420 on the cap structure 406 and the layer 404 having porous regions 410 and non-porous regions 412, according to one embodiment.

In the example illustrated in FIG. 4, the layer 404 is attached to the portion of the bonding layer 420 including an adhesion layer 428 (or seed layer) comprised of approximately of 50 nm of titanium (Ti), a barrier layer 426 comprised approximately of 250 nm of nickel (Ni), a bond 424 comprised approximately of 4000 nm of 80% gold/20% tin alloy, and a capping layer 422 comprised approximately of 50 nm of gold (Au).

The cap structure 406 is attached to the portion of the bonding layer 420 including an adhesion layer 434 (or seed layer) comprised of approximately of 50 nm of titanium (Ti), a barrier layer 432 comprised approximately of 250 nm of nickel (Ni), and a capping layer 430 comprised approximately of 50 nm of gold (Au). Note that additional or less layers may be included. Although materials and thicknesses are specified as an example, alternate materials of varying thicknesses may be used.

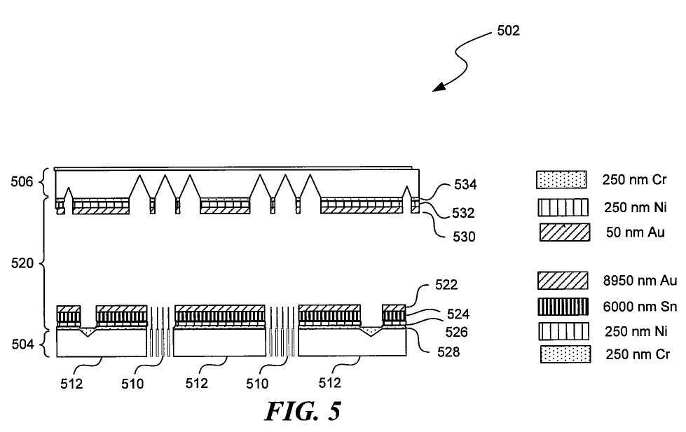

FIG. 5 illustrates a side view of the evaporator 502 showing a further example of the compositions of the bonding layer 520 on the cap structure 506 and the layer 504 with porous regions 510 and non-porous regions 512, according to one embodiment.

In this example, the layer 504 is attached to the portion of the bonding layer 520 including a adhesion layer 528 (or seed layer) comprised approximately of 250 nm of chromium (Cr), a diffusion barrier layer of Ni of 250 nm, a bond having a first element 524 of comprised approximately of 6000 nm of tin (Sn) and a second element 522 of approximately 8950 nm of gold (Au). The first tin element 524 and the second gold element 522 can be formed by separate electroplating processes. The layer set follows a general design rule that in order to obtain an alloy with 80% gold and 20% tin, the total thickness of the gold layer including capping layers can be divided by a factor of approximately 1.5 to determine the thickness of the tin layer.

The cap structure 506 is attached to the portion of the bonding layer 520 including an adhesion layer 534 (or, a seed layer) comprised approximately of 250 nm of chromium (Cr), a diffusion barrier layer 532 comprise of approximately 250 nm of nickel (Ni), and a capping layer 530 comprised approximately of 50 nm of gold (Au). Note that additional or less layers may be included. Although materials and thicknesses are specified as an example, alternate materials of varying thicknesses may be used.

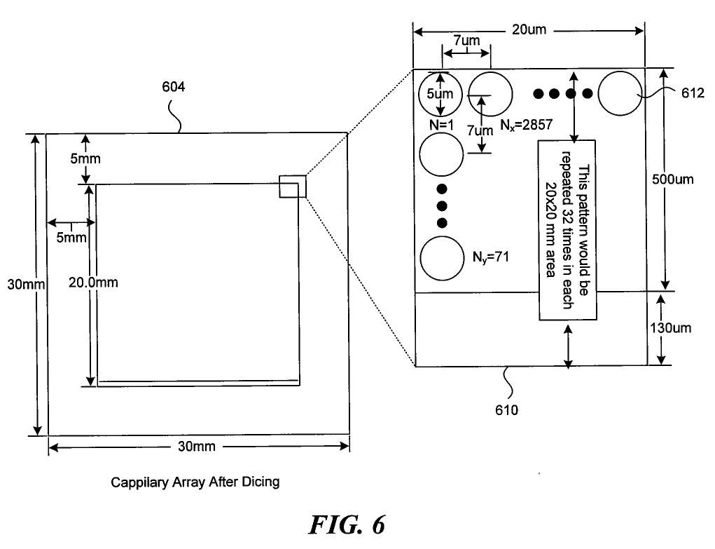

FIG. 6 illustrates a diagrammatic view of the porous semiconductor layer 604 of the evaporator showing the array of the pores (capillaries) 610, according to one embodiment.

In one example, each pore has a diameter that is preferably approximately 5 μm with approximately a 7 μm pitch. Typically, the pores can have a diameter anywhere between 0.2 μm and 50 μm. The pores typically have a high length to diameter aspect ratio that is, for example, greater than 60-200. The depth of the pores can be anywhere between 300-1000 μm but more preferably between 400-600 μm. Specific dimensions are illustrated and described only with reference to one example; alternative dimensions may be used without deviating from the novel scope of this disclosure.

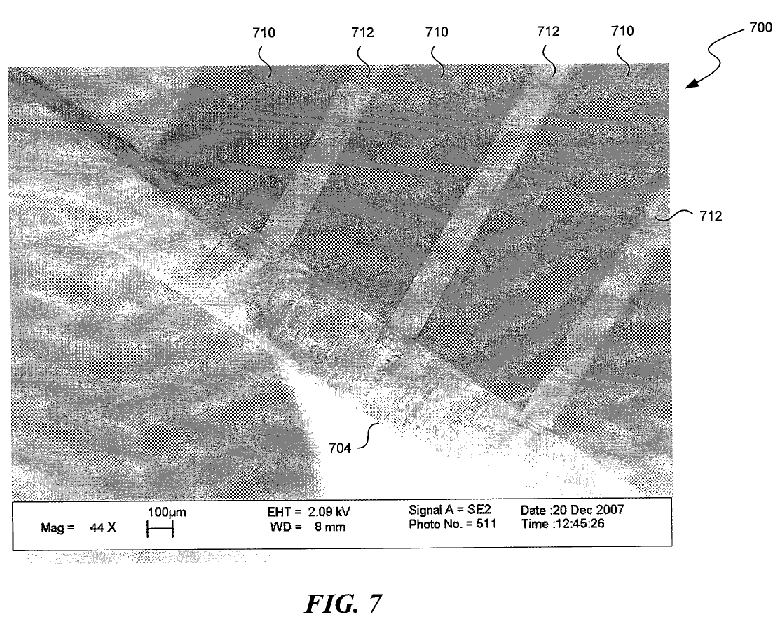

FIG. 7 is an SEM image 700 showing a patterned array of porous regions 710 and the non-porous regions 712 in the semiconductor layer 704 of the evaporator, according to one embodiment.

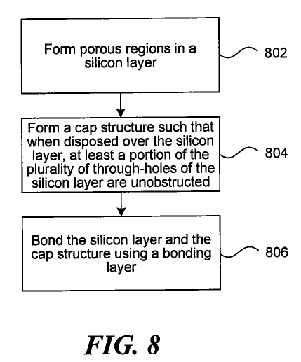

FIG. 8 is a flow chart illustrating a process for forming an evaporator of a two-phase cooling apparatus, according to one embodiment.

In process 802, porous regions are formed in a semiconductor material (e.g., a silicon layer, an SOI layer, a germanium layer, a sapphire layer, and/or a silicon carbide layer). The porous regions of the semiconductor material include through-holes that extend through the thickness of the material (e.g., the silicon layer). The semiconductor material also includes areas of non-porous regions that are generally exclusive of areas of the porous regions.

In process 804, a cap structure is formed. The cap structure is formed with a structure such that when disposed over the semiconductor material, at least a portion of the through-holes in the semiconductor material layer are unobstructed. An example of the porous region formation process and the cap structure fabrication process is described with further reference to co-pending U.S. patent application Ser. No. 11/933,000 entitled “METHOD OF FABRICATING SEMICONDUCTOR-BASED POROUS STRUCTURE”, filed Oct. 31, 2007, the contents of which are incorporated herein by reference.

In process 806, the semiconductor material layer and the cap structure are bonded using a bonding layer. An example of the physical structure of the bonding layer is illustrated with reference to FIG. 2A-B. The bonding layer is formed on the semiconductor material layer at a portion of the non-porous regions. In one embodiment, the bonding layer is compatible with liquids or solvents and forms a hermetic seal between the semiconductor material layer (e.g., silicon layer) and the cap structure.

The bond surface and the bonding layer may be formed via any known and/or convenient bonding means. In general, the bond formation process is a function of the temperature sensitivity of any devices coupled with the two-phase cooling apparatus. For example, if the bonding of the semiconductor material and the cap structure is performed after temperature sensitive devices have already been packaged on the cap structure, then the solder bond may need to be performed at a temperature around or below a certain temperature (e.g., typically around or less than approximately 280° C.). In this situation, an alloy of gold (50%) and indium (50%) can be used since the alloy forms at a relatively low temperature around or slightly above 157 C.

In general, if the bond is formed before any temperature sensitive device is connected with the two-phase cooling apparatus, a bond or bonding process requiring higher temperatures can be used.

In one embodiment, the bonding of the cap structure and the semiconductor layer (e.g., the first layer 404) can be achieved via silicon fusion bonding, eutectic bonding, and/or glass frit bonding. Alternatively, the bonding can be achieved via solid liquid interface diffusion (SLID)/transient liquid phase (TLP) bonding.

Silicon fusion bonding typically requires that the surface roughness be less than ˜20 angstroms to yield optimal bonds. With silicon fusion bonding, a high pressure and temperature are applied to join the materials to be bonded. The cap structure and the semiconductor material layer can be placed in close contact and heated between 300° C.-800° C. The process may be followed by an anneal process at approximately 800-1,100° C. in oxygen or nitrogen. The fusion bond is ideal in that the bond posses the same or similar mechanical strength as the parent semiconductor material (e.g., silicon). In addition, the bond may be ideal in that it does not suffer from the effects of thermal stress induced by coefficient of thermal expansion mismatch since the bond joint is homogenous in material. However, this technique is difficult to achieve when the surface roughness exceeds approximately 20 angstroms.

In one embodiment, glass frit bonding may be used. For example, to perform glass frit bonding, a glass frit is applied through a screen to pattern the glass frit paste. The wafers can then be heated to 600° C. for bonding. Generally glass has good wetting characteristics and can fill in surface roughness as it is in a liquid state when heated above the glass phase transition temperature. Typically glass has a thermal conductivity in the 1-2 W/mK range.

In addition, a gold/Si eutectic bond may also be formed by heating the wafers placed in contact to approximately 350° C. The gold and silicon may diffuse together and form a connection. Eutectic bonds have preferable characteristics including high thermal conductivity property.

In one embodiment, solder reflow bonding is used to bond the cap structure and the silicon layer. Solder reflow bonding has the advantage of being relatively insensitive to surface non-uniformities and other types of roughness. In addition, a lower force (e.g. <1 KN) and temperature (e.g., <˜350° C.) is required for solder reflow bonding which may be advantage since it lowers the risk of damaging wafers during bonding. Furthermore, solder reflow bonding can be made fluxless when done in a reducing or vacuum environment.

In one embodiment, transient liquid phase (TLP) bonding is used to bond the cap structure and the semiconductor material (silicon) layer. The TLP bond may also be referred as a solid liquid interface diffusion (SLID) bond. The TLP or SLID bond typically creates a strong bond that is generally interface-free with little or no remnant of the bonding agent. Furthermore, TLP bonding also has the advantage of being relatively insensitive to surface non-uniformities and other types of roughness. In addition, a lower force and temperature (e.g., <˜250° C.) is required for TLP bonding for example (Au50% In50%) which may be advantage since it lowers the risk of damaging wafers during bonding. Furthermore, TLP bonding is also generally fluxless.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A two-phase cooling apparatus, comprising:
an evaporator comprising:
a first layer having porous regions and non-porous regions, the porous regions having a plurality of through-holes extending through the first layer;
a cap structure formed such that when disposed over the first layer, at least a portion of the plurality of through-holes are unobstructed to liquid or vapor flow;
a bonding layer formed between the first layer and the cap structure, the bonding layer in contact with at least a portion of the non-porous regions of the first layer, the bonding layer comprising a bond; and
wherein the bonding layer is compatible with liquid and forms a hermetic seal between the first layer and the cap structure.

2. The apparatus of claim 1, wherein,
the first layer comprise substantially of crystalline silicon; and
the cap structure comprises substantially of thermally conductive material and is formed with a plurality of protruding structures that extend toward the first layer and a portion of the plurality of protruding structures is in contact with the bonding layer.

3. The apparatus of claim 1, wherein, the bonding layer comprises an adhesion layer to promote adhesion of the bond to the first layer.

4. The apparatus of claim 1, wherein, the bonding layer, further comprises, a barrier layer to mitigate diffusion of the bond into the adhesion layer or the first layer.

5. The apparatus of claim 1, wherein, the bonding layer, further comprises, a capping layer to prevent oxidation of the bond.

6. The apparatus of claim 1, wherein, the bond comprises substantially of gold (Au) and tin (Sn) or gold (Au) and indium (In).

7. The apparatus of claim 1, wherein, the bond comprises substantially of gold (Au) and copper (Cu) or nickel (Ni) and gold (Au).

8. The apparatus of claim 1, wherein, the bond comprises substantially of copper (Cu) and silver (Ag) or tin (Sn) and silver (Ag).

9. The apparatus of claim 1, wherein, the bond comprises substantially of SAC305, tin (Sn), silver (Ag), and copper (Cu).

10. The apparatus of claim 1, wherein, the bond comprises substantially of, one of, SAC105, SAC205, and SAC405.

11. The apparatus of claim 3, wherein, the adhesion layer is deposited on the first layer and comprises, one or more of, aluminum (Al), chromium (Cr), titanium (Ti), and titanium-tungsten (TiW).

12. The apparatus of claim 4, wherein, the barrier layer is deposited on the adhesion layer and comprises substantially of, one or more of, nickel (Ni), nickel/chromium alloy, platnium (Pt), tantalum (Ta), hafnium (Hf), zirconium (Zr), Molybdenum (Mo), niobium (Nb), zirconium (Zr), vanadium (V), and tungsten (W).

13. The apparatus of claim 4, wherein, the barrier layer comprises conductive ceramics, including, one or more of, tantalum nitride (TaN), indium oxide (In₂O₃), copper silicide (Cu₅Si), and titanium nitride (TiN).

14. The apparatus of claim 5, wherein, the capping layer is deposited on the bond and comprises substantially of, gold (Au).

15. A two-phase cooling apparatus, comprising:
an evaporator comprising:
a silicon layer having porous regions and non-porous regions, the porous regions having a plurality of through-holes extending through the silicon layer;
a cap structure formed such that when disposed over the silicon layer, at least a portion of the plurality of through-holes are unobstructed to liquid or vapor flow;
a bonding layer formed between the silicon layer and the cap structure, the bonding layer in contact with at least a portion of the non-porous regions of the first layer;
the bonding layer comprising:
an adhesion layer disposed on at least a portion of the non-porous regions of the silicon layer;
a barrier layer disposed on the adhesion layer; and
a bond comprised substantially of gold and tin disposed on the barrier layer;
wherein the bonding layer is compatible with liquid and forms a hermetic seal between the silicon layer and the cap structure.

16. A method of forming an evaporator of a two-phase cooling apparatus, comprising:
forming porous regions in a semiconductor material layer, the porous regions having a plurality of through-holes in the semiconductor material layer, the semiconductor material layer having non-porous regions exclusive of the porous regions;
forming a cap structure such that when disposed over the semiconductor material layer, at least a portion of the plurality of through-holes of the semiconductor material layer are unobstructed;
bonding the silicon layer and the cap structure using a bonding layer;
wherein, the bonding layer is formed on the semiconductor material layer at a portion of the non-porous regions; and
wherein the bonding layer is compatible with liquid and forms a hermetic seal between the semiconductor material layer and the cap structure.

17. The method of claim 16, wherein, the bonding is performed via silicon fusion bonding, eutectic bonding, or glass frit bonding.

18. The method of claim 16, wherein, the bonding is performed via, solder reflow bonding.

19. The method of claim 16, wherein, the bonding is performed via solid liquid interface diffusion (SLID) or transient liquid phase (TLP) bonding.

20. The method of claim 16, wherein, the bonding layer is formed via a gold/silicon eutectic bond.
